(19) United States
(12) Patent Application Publication
(10) Pub. No.: US 2007/0115999 A1
(43) Pub. Date: May 24, 2007

(54) METHODS FOR STANDARDIZING MEDICAL IMAGE INFORMATION AND APPLICATIONS FOR USING THE SAME

(76) Inventor: Jianming QU, Chengdu (CN)

Correspondence Address: MATTHIAS SCHOLL, 14781 MEMORIAL DRIVE, SUITE 1319, HOUSTON, TX, 77079, US

(21) Appl. No.: 11/551,416

(22) Filed: Oct. 20, 2006

(30) Foreign Application Priority Data
Oct. 21, 2005 (CN) 200510021911.3

(51) Int. Cl. H04L 12/56; H04L 12/28

(52) U.S. Cl. 370/392

(57) ABSTRACT

The present invention discloses a method for standardizing medical digital image information based on a desired format. The method for standardizing digital medical image information based on the required format in accordance with the present invention comprises transmitting medical image information to a conversion module and (a) if the transmitted image is a DICOM standard data, (1) decoding the information service metadata and pixel data from the original file information header, (2) reorganizing the information service metadata according to a desired format to form a new file information header, and (3) combining the new information service metadata with the pixel data resulting in the desired standard digital image information; or (b) if the data is not a DICOM standard data, (1) inspecting the data to determine whether it has been received directly from a hardware; (2) if the data has been received directly from a hardware, reorganizing the file information header directly based on the desired format; or if the data has not been received directly from a hardware, decoding the pixel data based on its current format, and then reorganizing the file information header based on the desired format; (3) after the file information header is reorganized, reorganizing the pixel data according to the DICOM standard; and (4) combining the new information service metadata with the pixel data resulting in the desired standard digital image information.

### BACKGROUND OF THE INVENTION

1. Field of the Invention

This invention relates to methods for standardizing medical image information and applications of these methods.

2. Description of the Related Art

Modem medical technology universally adopts medical imaging (e.g., computed tomography (CT), B-mode ultrasound, etc.) to capture the position of pathological changes, such as fractures, tumors, and blood clothes, within the human body, and to allow a physician to make a diagnosis based thereon. This method of making diagnosis is preferred to and generally more accurate than, for example, observing the peripheral characteristics of a patient by eye or touch alone.

However, medical imaging-assisted methods of diagnosis are not without shortcomings. These include among others (1) subjectivity of diagnosis affected by experience in reading medical images; (2) variance of diagnosis affected by educational background, experience, and judgment; and (3) difficulty in storing, printing, and transmitting information contained in medical images. Clearly, the area of medical imaging, and specifically the area of diagnosing based on medical imaging data presents much opportunity for improvement.

### SUMMARY OF THE INVENTION

The present invention arose in the context of the above problems. Specifically, it is one objective of the present invention to provide a method for standardizing medical digital image information based on a desired format.

To achieve the above objective, a method for standardizing medical digital image information based on a desired format comprises transmitting medical image information to a conversion module and (a) if the transmitted image is a DICOM standard data type, (1) decoding the information service metadata and pixel data from the original file information header, (2) reorganizing the information service metadata according to a desired format to form a new file information header, and (3) combining the new information service metadata with the pixel data resulting in the desired standard digital image information; or (b) if the data is not a DICOM standard data type, (1) inspecting the data to determine whether it has been received directly from a hardware; (2) if the data has been received directly from a hardware, reorganizing the file information header directly based on the desired format; if the data has not been received directly from a hardware, decoding the pixel data based on its current format, and then reorganizing the file information header based on the desired format; (3) after the file information header is reorganized, reorganizing the pixel data according to the DICOM standard; and (4) combining the new information service metadata with the pixel data resulting in the desired standard digital image information.

In certain embodiments of the present invention, the standard digital image information obtained in accordance with the method of the present invention is stored, printed, and/or transmitted via network, wherein during the storage process, the transmission syntax of the data is negotiated between a client and a server prior to image transmission; and if the server accepts the transmission syntax, the original data is sent sectionally by the client to the server, wherein, the file information header of the digital image is not reorganized based on the transmission syntax specified by the server.

In certain embodiments of the present invention, an operation is created at the client side by means of a socket used for the purpose of listening and binding a local address prior to the server receiving image information from a client; the socket is kept in a constant listening status; when a connection request is received, the listening socket accepts a request and creates a new sub-operation, wherein a new socket is also created for receiving data; and when multiple requests come in at the same time, the operation will create multiple sub-operations so that all of the requests can be processed therein.

In further embodiment of the present invention, a printing service client according to the provisions of the digital image protocol receives image data obtained from the ImageBox-N-SET PDU. In certain class of this embodiment, the printing service client resides on CT or CR workstations having only a printing function but no storage function.

As a result, the digital medical image information processed in accordance with the method of the present invention has the standardized characteristics such as character encoding and digitization. The digital medical image information can be stored quickly and transmitted by network easily; it is convenient for data processing, storage and management. By utilizing the methods of this invention, disease diagnosis is more accurate, quick, straightforward, and convenient. The medical information can also be circulated and communicated among various medical institutions contributing to the development of the medical profession.

### BRIEF DISCRIPTION OF THE DRAWINGS

Preferred embodiments of the present invention will hereinafter be described in more detail with reference to the accompanying drawings in which:

FIG. 1 is flow chart showing a method for standardizing medical digital image information based on the required format in accordance with the present invention;

FIG. 2 is a flow chart showing a operation of a storage client for the standardized digital image information in accordance with the present invention;

FIG. 3 is a flow chart showing a sub-operation of a storage client for the standardized digital image information in accordance with the present invention; and

FIG. 4 is a flow chart showing a sub-operation of a printing client for the standardized digital image information in accordance with the present invention.

### DETAILED DESCRIPTION OF THE INVENTION

1. Definitions

The DICOM standard

Digital Imaging and Communications in Medicine (DICOM) is a standard promulgated by the National Electrical Manufacturers Association (NEMA) that facilitates interoperability of medical imaging equipment by specifying a set of protocols to be followed by devices; the syntax and semantics of commands and associated information which can be exchanged using these protocols; and a file format and a medical directory structure to facilitate access to the images and related information stored on interchange media.

DICOM Application Entities (AEs) communicate via a TCP/IP network with an Upper Layer (UL) Protocol. The UL Protocol defines the following services: A-ASSOCIATE, A-RELEASE, A-ABORT, A-P-ABORT and P-DATA. These services are negotiated with Protocol Data Units (PDU). The Protocol Data Units (PDUs) are the message formats exchanged between peer entities within a layer. A PDU shall consist of protocol control information and user data. PDUs are constructed by mandatory fixed fields followed by optional variable fields which contain one or more items and/or sub-items. DICOM Application Entities send and receive PDUs via a TCP/IP network. The UL Protocol services define the sequence of TCP/IP events between Application Entities whereas PDUs are the data structures which contain information about the events.

The DICOM UL protocol consists of seven Protocol Data Units: (a) A-ASSOCIATE-RQ PDU; (b) A-ASSOCIATE-AC PDU; (c) A-ASSOCIATE-RJ PDU; (d) P-DATA-TF PDU; (e) A-RELEASE-RQ PDU; (f) A-RELEASE-RP PDU; and (g) A-ABORT PDU.

ASSOCIATE-RQ PDU, A-ASSOCIATE-AC PDU, and A-ASSOCIATE-RJ PDU are PDUs used to establish or reject an association in the first phase of any instance of communication between peer DICOM AEs. A-RELEASE-RQ PDU and A-RELEASE-RP PDU are PDUs used to terminate an association in the final phase of any instance of communication between peer DICOM AEs.

There is also another protocol layer called DICOM Message Service Element (DIMSE). The DIMSE protocol defines operations and responses between Application Entities. DIMSE operations and responses are sent and received via UL Protocol P-DATA service. The P-DATA-TF PDU encapsulates DIMSE operations and responses.

The Storage AE is invoked by the job control interface that is responsible for processing network archival tasks. The job consists of data describing the instances marked for storage and the destination. An internal daemon process triggered by a job for a specific network destination initiates a C-STORE request (C-STORE-RQ) to store images. If the process successfully establishes an Association to a remote Application Entity, it will transfer each marked instance one after another via the open Association. Status of the transfer is reported through the job control interface. Only one job will be active at a time. If the C-STORE Response from the remote Application (C-STORE-AC) contains a status other than Success or Warning, the Association is aborted and the related Job is switched to a failed state. It can be restarted any time by user interaction or, if configured, by automated retry. The Storage AE attempts to initiate a new Association in order to issue a C-STORE request. If the job contains multiple images, then multiple C-STORE requests will be issued over the same Association.

N-GET on the Printer SOP Class is used to obtain current printer status information. N-GET-RQ is a request message and N-GET-RSP is a response and confirmation message. The Printer Status information is evaluated as follows:
1. If Printer status is NORMAL, the print-job continues to be printed.
2. If Printer status is FAILURE, the print-job is marked as failed. The contents of Printer Status Info are logged and reported to the user via the job control application.
3. If Printer status is WARNING, the print-job continues to be printed. The contents of Printer Status Info are logged and reported to the user via the job control application.

The Basic Film Session Information Object Definition (IOD) describes the presentation parameters which are common for all the films of a film session (e.g. number of films, film destination). The Basic Film Box IOD is an abstraction of the presentation of one film of the film session. The Basic Film Box IOD describes the presentation parameters which are common for all images on a given sheet of film. The Basic Film Session SOP Instances shall be created before the Film Box SOP Instances are created. The Basic Image Box IOD is an abstraction of the presentation of an image and image-related data in the image area of a film. The Basic Image Box IOD describes the presentation parameters and image pixel data which apply to a single image of a sheet of film.

The N-CREATE is used to create an instance of the Basic Film Session SOP Class. The N-SET may be used to update an instance of the Basic Film Session SOP Class. The N-ACTION is used to print the film session; i.e. to print all the films which belong to the film session in the order that they were received. The N-DELETE is used to delete the complete Basic Film Session SOP Instance hierarchy. As a result, all references to Image SOP Instances within the film session are deleted.

2. Description

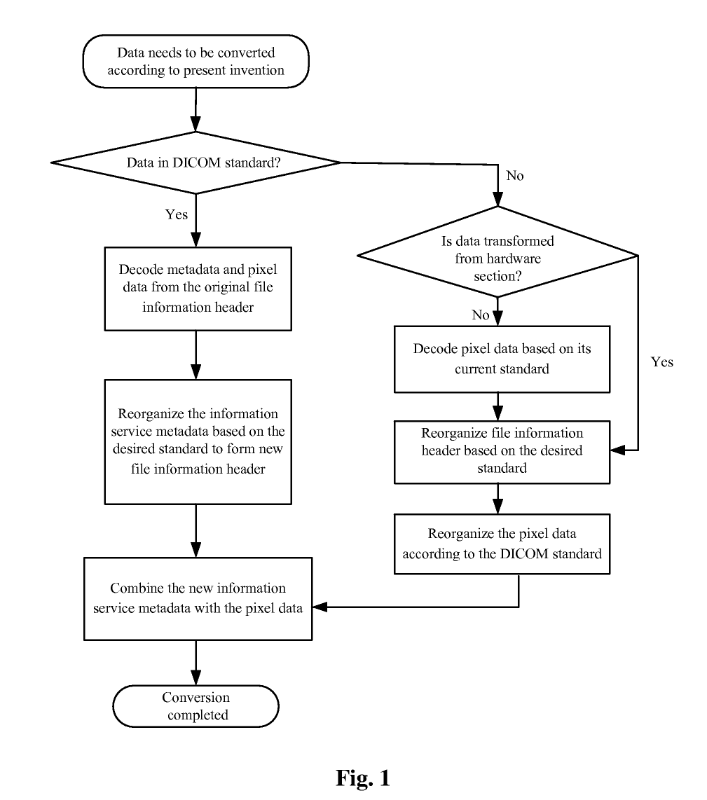

A method for standardizing medical digital image information based on a desired format comprises transmitting medical image information to a conversion module. As exemplified in FIG. 1, the medical digital image information (i.e., the data to be converted) is initially inspected to ascertain whether it is a DICOM standard data. If the data is a DICOM standard data, (1) the information service metadata and pixel data are decoded from the original file information header, (2) the information service metadata is reorganized according to a desired format to form a new file information header, and (3) the new information service metadata is combined with the pixel data resulting in the desired standard digital image information (conversion is completed). If the data is not a DICOM standard data, (1) the data is inspected to determine whether it has been received directly from a hardware; (2) if yes, then the file information header is directly reorganized based on the desired format, if not, the pixel data is first decoded based on its current format, and then the file information header is reorganized based on the desired format; (3) after the file information header is reorganized, the pixel data is reorganized according to the DICOM standard, and (4) the new information service metadata is combined with the pixel data resulting in the desired standard digital image information (conversion is completed).

Referring to FIG. 1, the data to be converted can be in DICOM 3.0 format, a lower DICOM format, a general image storage format, such as BMP or JPEG, or in any digital format encoded from an analog signal by the hardware section of a DICOM tollgate. As a result of the conversion process, the data (either in a standard or a non-standard medical digital image information format) is transformed into a desired, standardized information format (in general, it is character encoded and digitized).

The standard digital image information obtained in accordance with the method of the present invention is stored, printed, and/or transmitted via network. During the storage process, the transmission syntax of the data is negotiated between a client and a server prior to image transmission. If the server accepts the transmission syntax, then the original data is sent sectionally by the client to the server. Specifically, it is not necessary to reorganize the file information header of the digital image based on the transmission syntax specified by the server, and therefore, the transmission efficiency is significantly increased.

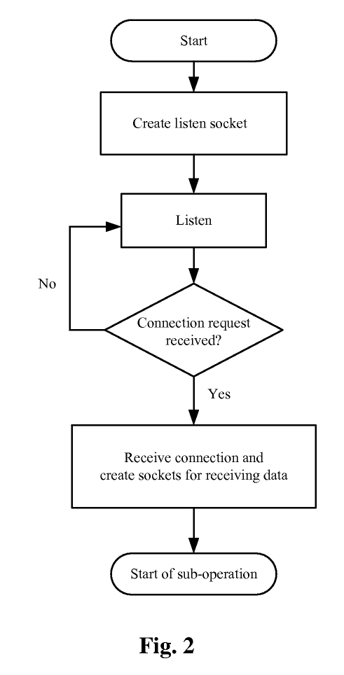

As shown in FIG. 2, an operation is created at the client side by means of a socket used for the purpose of listening and binding a local address prior to the server receiving image information from a client. The socket is kept in a constant listening status. When a connection request is received, the listening socket will accept the request and create a new sub-operation, wherein a new socket is also created for receiving data. When multiple requests come in at the same time, the operation will create multiple sub-operations so that all of the requests can be processed therein. The use of multiple sub-operations allows for a reduction of processing time.

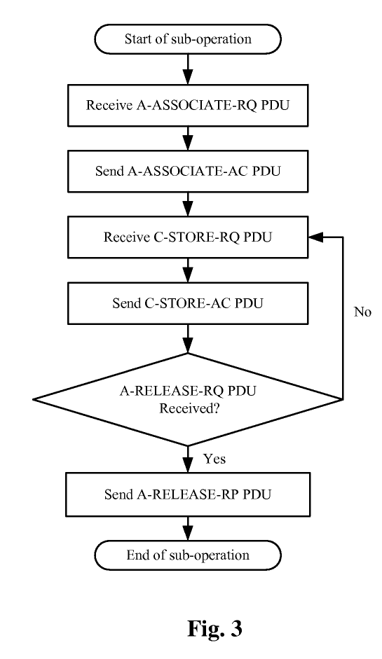

FIG. 3 is a flow chart of a storage sub-operation in accordance with the present invention. In every new sub-operation, if an A-ASSOCIATE-RQ PDU is not received in a specified time, then the sub-operation will be terminated. If an A-ASSOCIATE-RQ PDU is received in a specified time, a response PDU will be sent and the server will receive data from the client. In this way, the C-STORE-RQ PDU can also be verified. If one or more images remain to be sent to the server after the C-STORE-AC PDU is sent, another C-STORE-RQ PDU will be sent. Otherwise, an A-RELEASE-RQ PDU will be issued.

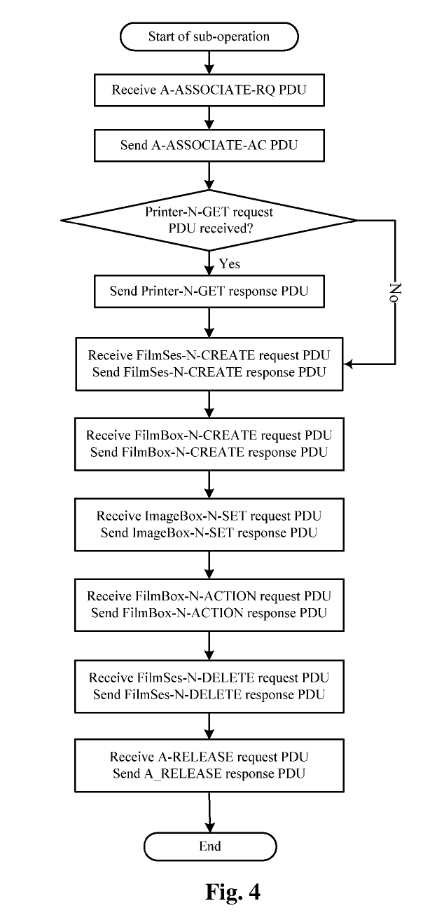

FIG. 4 shows a flow chart of a printing sub-operation in accordance with the present invention. During the printing process, a printing service client according to the provisions of the digital image protocol receives image data obtained from the ImageBox-N-SET PDU. The printing sub-operation is useful, for example, for CT or CR workstations having only the printing function but no storage function.

What is claimed is:

1. A method for standardizing a medical digital image information having information service metadata and pixel data, according to a desired format, comprising:
transmitting medical image information to a conversion module;
decoding said information service metadata and said pixel data;
reorganizing said information service metadata according to said desired format into a new information service metadata forming a new file information header; and
combining said new information service metadata with said pixel data.

2. The method of claim 1 wherein said medical digital image information, said information service metadata and said pixel data are DICOM standard data

3. The method of claim 1, comprising further storing, printing, and/or transmitting via network said medical digital image information, wherein
during a storage process, a transmission syntax is negotiated between a client and a server prior to image transmission; and
if the server accepts the transmission syntax, the original data is sent sectionally by the client to the server, and the file information header of the digital image is not reorganized based on the transmission syntax specified by the server.

4. The method of claim 3, wherein
during said storing, printing, and/or transmitting via network, an operation is created at the client side by means of a socket used for the purpose of listening and binding a local address prior to the server receiving image information from a client;
said socket is kept in a constant listening status;
when a connection request is received, said listening socket accepts a request and creates a new sub-operation, wherein a new socket is also created for receiving data; and
when multiple requests are received at the same time, the operation will create multiple sub-operations so that all of the requests can be processed therein.

5. The method of claim 4, wherein a printing service client receives image data according to the provisions of a digital image protocol.

6. A method for standardizing medical digital image information having information service metadata and pixel data, according to a desired format, comprising:
transmitting medical image information to a conversion module;
inspecting the data to determine whether it has been received directly from a hardware;
if the data has been received directly from a hardware, reorganizing the file information header directly based on the desired format; or if the data has not been received directly from a hardware, decoding the pixel data based on its current format, and then reorganizing the file information header based on the desired format;
after the file information header is reorganized, reorganizing the pixel data according to the DICOM standard; and
combining the new information service metadata with the pixel data resulting in the desired standard digital image information.

7. The method of claim 6 wherein the medical digital image information wherein said information service metadata and pixel data is not a DICOM standard data.

8. The method of claim 6, comprising further storing, printing, and/or transmitting via network said medical digital image information, wherein
during a storage process, a transmission syntax is negotiated between a client and a server prior to image transmission; and
if the server accepts the transmission syntax, the original data is sent sectionally by the client to the server, and the file information header of the digital image is not reorganized based on the transmission syntax specified by the server.

9. The method of claim 8, wherein
during said storing, printing, and/or transmitting via network, an operation is created at the client side by means of a socket used for the purpose of listening and binding a local address prior to the server receiving image information from a client;
said socket is kept in a constant listening status;
when a connection request is received, said listening socket accepts a request and creates a new sub-operation, wherein a new socket is also created for receiving data; and
when multiple requests are received at the same time, the operation will create multiple sub-operations so that all of the requests can be processed therein.

10. The method of claim 9, wherein a printing service client receives image data according to the provisions of a digital image protocol.
